(19) United States
(12) Patent Application Publication
(10) Pub. No.: US 2025/0029196 A1
(43) Pub. Date: Jan. 23, 2025

(54) INCIDENT RESPONSE NOTIFICATION SYSTEM

(71) Applicant: Subrahmanyam Pilaka Venkata, Toronto (CA)

(72) Inventor: Subrahmanyam Pilaka Venkata, Toronto (CA)

(21) Appl. No.: 18/906,867

(22) Filed: Oct. 4, 2024

Related U.S. Application Data
(63) Continuation-in-part of application No. PCT/IB2023/060073, filed on Oct. 6, 2023.
(60) Provisional application No. 63/450,487, filed on Mar. 7, 2023.

(51) Int. Cl. G06Q 50/26

(52) U.S. Cl. CPC G06Q 50/265

(57) ABSTRACT

An incident response notification system may be provided by identifying, at a central service, a plurality of user devices to receive a reaction plan for an ongoing incident in an environment; customizing the reaction plan to produce a plurality of individualized versions, wherein each individualized version corresponds to an individual user device of the plurality of user devices and is customized based a device type of each individual user device and a role of a user associated with each individual user device in responding to the ongoing incident; and transmitting the individualized version to each corresponding individual user device of the plurality of user devices.

### CROSS-REFERENCES TO RELATED DISCLOSURES

The present disclosure is a continuation-in-part of co-pending Patent Cooperation Treaty (PCT) application having serial number PCT/IB2023/060073 and having the title “INCIDENT RESPONSE NOTIFICATION SYSTEM”, which was filed on 2023 Oct. 6 and is incorporated by reference herein in its entirety, and from which the present disclosure claims all rights of priority and benefit according to 35 U.S.C. §§ 111 (a), 363, and 365. Co-pending PCT application PCT/IB2023/060073 claims the benefit of U.S. Provisional Patent Application No. 63/450,487 filed on 2023 Mar. 7, from which the present disclosure claims all rights of priority and benefit, and the entirety of which is also incorporated herein by reference.

### FIELD

The present disclosure is generally related to coordination among sensors, and more particularly to organizing signals received from wirelessly deployed sensors into a coherent action plan accessible to a plurality of users for incidents indented by several sensors, individually or in tandem.

### SUMMARY

The present disclosure provides an incident response notification system using wirelessly deployed sensors communicated to and coordinate through a central service, which is accessible by a plurality of users. The locations of these sensors are known to the central service, so that when a sensor generates an alert or other report, the central service can track the various events monitored by the sensors across time and space. By amalgamating the reports from several sensors, the central service can identify trends in events (e.g., a flow of events) to provide one or more users with relevant alerts, reaction plans based on the flow of events, and predictions for future events in the flow of events. Accordingly, the present disclosure provides an improved user experience and additional functionality for various sensors and the users of those sensors.

Additionally, the present disclosure provides for a standardized Application Program Interface (API) or data management standard so that different end-users, having different use cases and devices may be provided with customized alerts and other information related to the events and trends therein, from one or more separately managed locations. Accordingly, various systems managed by different parties can collate event data for use by various potentially affected end-users, thereby extending the ability to track and manage events beyond the confines of a single managed location. These data may be selectively shared selectively with the end-users based on the location, user type, and event type so that relevant event management and reaction plans are provided to interested parties (and irrelevant alerts are not provided).

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates an operations environment for an incident response notification system, according to embodiments of the present disclosure.

FIG. 2 is a flowchart for an example method of deploying an incident response notification system, according to embodiments of the present disclosure.

FIG. 3 is a flowchart for an example method of operating an incident response notification system, according to embodiments of the present disclosure.

FIG. 4 is a time chart of operating an incident response notification system, according to embodiments of the present disclosure.

FIG. 5 is a flowchart of an example incident response, according to embodiments of the present disclosure.

FIG. 6 is a flowchart of an example method for customizing an incident response, according to embodiments of the present disclosure.

FIGS. 7A-7B illustrate example graphical user interfaces for incident response and management, according to embodiments of the present disclosure.

FIG. 8 illustrates a scenario of an environmental incident in which the described central service generates and implements a response plan, according to embodiments of the present disclosure.

FIG. 9A illustrates a computing device, according to embodiments of the present disclosure.

FIGS. 9B-9C illustrate examples of various sensors and input/output devices as may be included in or in communication with various computing devices, according to embodiments of the present disclosure.

FIG. 10A illustrates an example of a hybrid peer-to-peer (P2P) computing model, according to embodiments of the present disclosure.

FIG. 10B illustrates an example of a structured P2P computing model, according to embodiments of the present disclosure.

### DETAILED DESCRIPTION

The present disclosure provides an incident response notification system using wirelessly deployed sensors communicated to and coordinate through a central service, which is accessible by a plurality of users. The locations of these sensors are known to the central service, so that when a sensor generates an alert or other report, the central service can track the various events monitored by the sensors across time and space. By amalgamating the reports from several sensors, the central service can identify trends in events (e.g., a flow of events) to provide one or more users with relevant alerts, reaction plans based on the flow of events, and predictions for future events in the flow of events. Accordingly, the present disclosure provides an improved user experience and additional functionality for various sensors and the users of those sensors. Additional benefits are provided in the data security of the decentralized reports received by the central service via the use of authentication and blockchain technologies to thereby provide reliable records of past events, and exclude bad actors from submitting false reports through the system. Further benefits and improvements offered by the incident response notification system will be apparent to those of skill in the art on reading the present disclosure.

Additionally, the present disclosure provides for a standardized Application Program Interface (API) or data management standard so that different end-users, having different use cases and devices may be provided with customized alerts and other information related to the events and trends therein, from one or more separately managed locations. Accordingly, various systems managed by different parties can collate event data for use by various potentially affected end-users, thereby extending the ability to track and manage events beyond the confines of a single managed location. These data may be selectively shared selectively with the end-users based on the location, user type, and event type so that relevant event management and reaction plans are provided to interested parties (and irrelevant alerts are not provided).

Although the present disclosure provides several examples of specific hardware, use cases, numbers of elements, terminology, and the like, these are provided to teach/demonstrate a non-limiting subset of the use cases and configurations of the claimed inventions. The examples and aspects disclosed herein are to be construed as merely illustrative and not a limitation of the scope of the present disclosure in any way. It will be apparent to those having skill in the art that changes may be made to the details of the below-described examples without departing from the underlying principles discussed. In other words, various modifications and improvements of the examples specifically disclosed in the description below are within the scope of the appended claims. For instance, any suitable combination of features of the various examples described is contemplated.

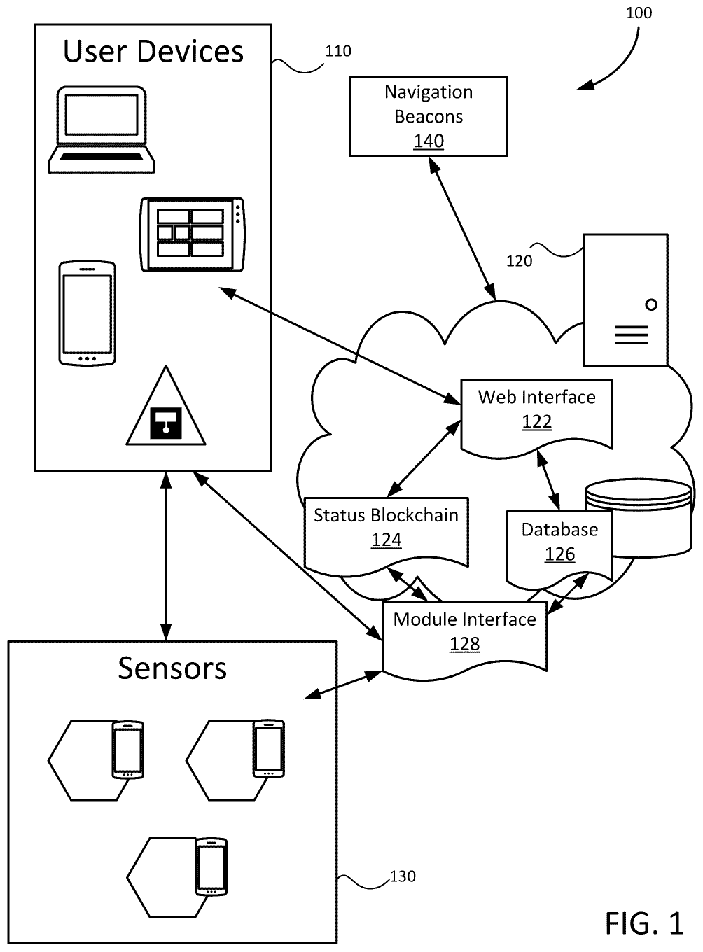

FIG. 1 illustrates an operations environment for an incident response notification system 100, according to embodiments of the present disclosure. The operations environment includes various user devices 110 that are associated with users concerned or interested in receiving status updates from various sensors 130 positioned throughout the operations environment, which are in communication with one another via a central service 120. The incident response notification system 100 is developed based on the sensors 130, which communicate with appropriate available Application Programming Interface (API) with the central service 120, which in turn reflects collected and processed incident information on mobile phones, laptops, or other user devices 110 through the Internet.

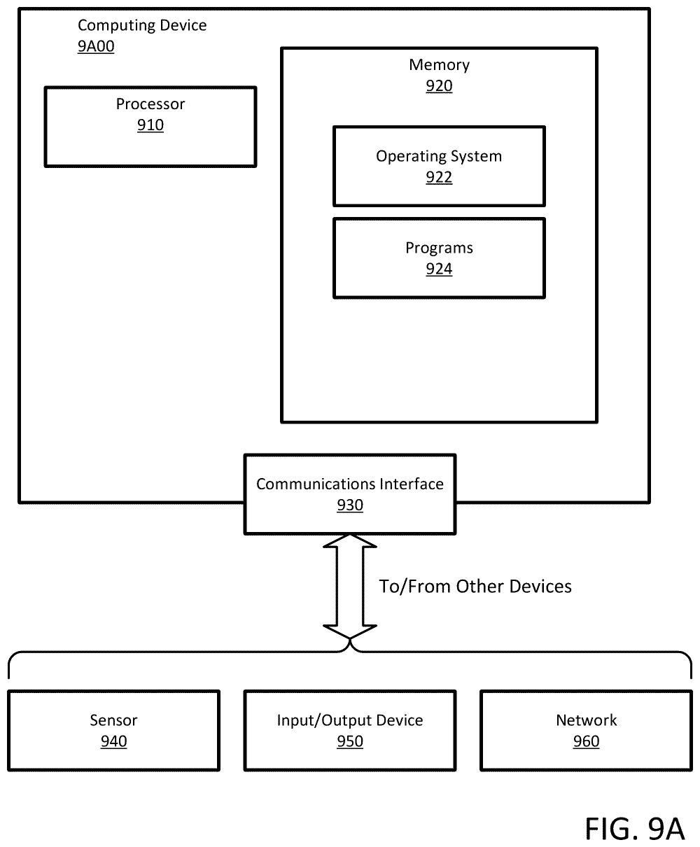

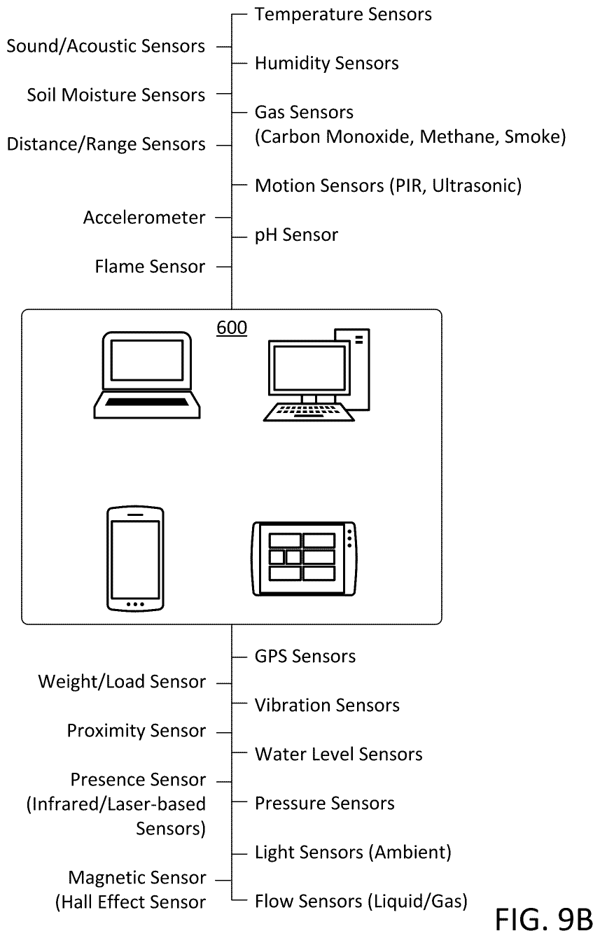

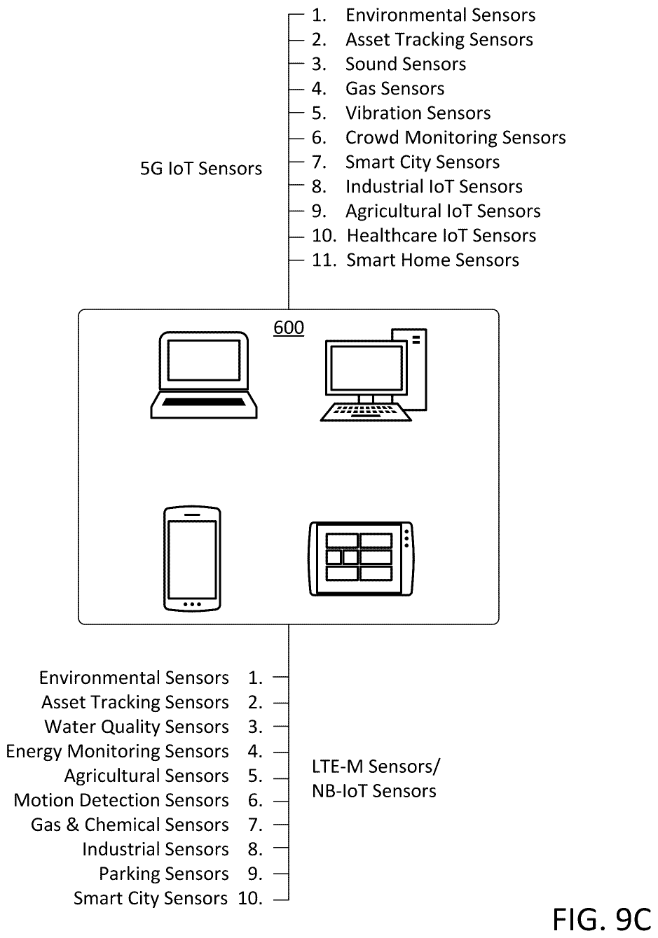

The user devices 110 may represent different types of computing devices (as described in greater detail in regard to FIG. 9A-9C), which can individually access the central service 120 to receive incident statuses and response plans from the central service 120 based on collected alerts from the sensors 130 and processed knowledge of the operations environment. In various embodiments, the user devices 110 may represent, by way of non-limiting example: mobile phones of various makes and models, personal computers, laptop computers, slate or tablet devices, smart watches, pagers, building control centers, fire panels, or the like.

The central service 120 acts as a gathering point for alert and status information from the various sensors 130 deployed to an operations environment and access point for those data for the various user devices 110. In various embodiments, the central service 120 may be a centralized, decentralized, or distributed computing environment that includes one or more computing devices (as described in greater detail in regard to FIGS. 9A-9C). The central service 120 may be accessible to the various user devices 110 and sensors 130 via interface software/logic, application program interfaces (APIs), direct software/logic, publicly accessible outputs (e.g., websites, apps), or the like.

In various embodiments, the central service 120 may include various centralized or decentralized databases, although if block chain technology is used, preferably a distributed database is used, with various hardware/storage layers providers selected for the deployment scenario. In various embodiments, the database may use available products like Oracle/SQL server/MongoDB, and if block chain technology is used an option for public, private, consortium, or hybrid operation is also selected.

In some embodiments, the central service 120 provides one or more APIs to interface between the user devices 110 (e.g., a web interface 122) and the sensors 130 (e.g., a module interface 128) and the various mappings or maps of the status reports from the sensors 130. For example, a module interface 128 may receive and reformat status reports from the sensors 130 or sensor elements in the user devices 110 to incorporate those reports into a format used by a status blockchain 124 or database 126 that is used to generate a map of the environment with the various statuses and reaction plans to those statuses when an incident is identified displayed thereon.

This map and other elements of the reaction plan may be accessible to the user devices 110 via the web interface 122, which can be output to applications executing on the various user devices 110 or via a website or app accessible and navigable by a user device 110. In various embodiments, the module interface 128 may be used for two-way communication with the sensors 130, to send queries or challenges from the central service 120 to the sensors 130 or to send portions of a reaction plan to the sensors 130. Additionally or alternatively, the central service 120 can use the web interface 122 to communicate with the sensors 130, which may act as user devices 110 for the purpose of receiving reaction plans in addition to the sensing functionality for reporting environmental conditions and alerts to the central service 120.

The sensors 130 may represent different types of devices used to detect various conditions in the operations environment and may include, or be in communication with a computing device (as described in more detail in regard to FIG. 9A) to report these conditions to the central service 120. In various embodiments, the sensors 130 may represent, by way of non-limiting example: fire alarms, thermostats, motion detectors, Analog & Infrared Sensor, Passive & Active Infrared Sensor, Temperature and proximity sensors, ultrasonic sensors, accelerometers, gyroscopes (e.g., position sensors), pressure sensors, magnetic field sensors (e.g., Hall Effect sensors), proximity sensors, light sensors, smoke/gas/alcohol sensors, touch sensors, color sensors, humidity sensors, or the like. In various embodiments, the sensors 130 are provided as Internet of Things (IoT) devices.

For example, digital Sensors/Fire-Alarms/Thermostats are placed at appropriate or required places in an environment to thereby send alert calls or communicate with the API for the central service 120, which records in a database these alert calls and communications. The collected data are then processed and reflected in website or app according to the need of the user or the application requirements for access by one or more user device 110. Whenever the sensors 130 are triggered, the updated communications are sent to the central service 120, which updates a table of records (e.g., a database), and simultaneously reflects these data in the website or by receiving alert calls and with help of cloud powered voice API integrating into website/app (application).

In some embodiments, the sensors 130 include voice detection sensors, which include a microphone or other sound collecting device, and logic to process utterances collected from the environment. The logic can include trigger word detection (e.g., scanning for a specific word or phrase before activating speech processing logic), noise filtering, sound level detection, or the like. The sensor 130 can locally process speech detected from the environment, or may transmit audio (compressed, encrypted, truncated, or combinations thereof) to an external service for processing. In various embodiments, the central service 120 includes an API (e.g., the web interface 122 or another interface) to send received utterances to a third-party transcription or speech processing service, or may locally process the voice data for data of interest. These voice alerts can include information from the environment that are identified by a human that may otherwise be difficult or impossible with the sensors 130 included in the environment.

In various embodiments, the sensors 130 include various output devices such as lights, speakers, buzzers, sirens, or the like, and combinations thereof to locally output the statuses collected by the sensors 130. For example, a sensor 130 of a smoke detector may include a strobe light and a siren that activate in response to detecting smoke in addition to reporting the detection of smoke to the central service 120. In some embodiments of sensors 130 that include speakers as output devices, the central service 120 can provide cues or voice files to the sensor 130 to output voice instructions to persons located in the environment. For example, in a large building in which a fire has occurred, the central service 120 can provide different voice instructions to different sensors 130 to guide persons in the building to the closest still-available exits.

Each of the sensors 130 includes a wireless communications device to wireless communicate with the central service 120. Because the various incidents that the sensors 130 are deployed to monitor may affect or disrupt wired communications, the wireless communications device may be included as an alternative or supplemental means of communication with a wired communication device. For example, a sensor 130 of a fire alarm may use wireless communications to continue reporting status information to the central service 120 regarding a detected fire even when a wire used for communications is disrupted. Similarly, to avoid loss of communications when wired power delivery is interrupted, the sensors 130 may include batteries or other power storage devices so that the sensors 130 may continue operations when wired power delivery is interrupted.

In various embodiments, the sensor 130 may use various wireless communications protocols to communicate with one another (e.g., as part of mesh network) or the central service 120. In various embodiments, the protocols may include, by way of non-limiting example: the IEEE 802.11 family of standards (e.g., WI-FI®, managed by the Wi-Fi Alliance), BLUETOOTH® (managed by the Bluetooth Special Interest Group), radio protocols, cellular communications protocols (e.g., long term evolution (LTE)), or the like. As one of ordinary skill in the art is expected to be familiar with various wireless communications protocols, and understand that these protocols are constantly being updated, the communication protocols used by the sensors 130 to communicate with one another, an intermediary device, or the central service are also contemplated to expand from the written examples, but generally includes local wireless networking communication protocols (e.g., Wi-Fi), near-field wireless communication protocols (e.g., Bluetooth), and cellular telephony communication protocols (e.g., LTE).

In various embodiments, sets of one or more sensors 130 may be under the control of a different entities, which can choose to share (or keep private) the data collected by the respective sensors. For example, a hotel operator may control a first set of sensors 130 deployed in and around a hotel campus, a shopping center operator may control a second set of sensors 130 deployed in and around a shopping mall campus that neighbors the hotel, and individual retailers operating within the shopping mall campus may control a third set of sensors 130 deployed in respective stores within the shopping mall campus, etc. In this example, the data collected from the shopping center operator and the retailers may be collected and amalgamated by the central service 120 for dissemination to various parties (using various devices) in the shopping mall, while information from the hotel is generally kept separate. However, in the event of an environmental incident that affects both locations, the central service 120 may share the data from the two locations to affected parties (e.g., first responders, emergency personnel, patrons of the shopping mall, guests at the hotel, etc.) so that a coordinated response to the environmental incident to improve the overall response to the incident, reduce risk to persons affected by the incident, and ensure that communications in receiving sensor data and sending analyzed data remain uninterrupted.

In various embodiments, the central service 120 is in communication with one or more navigation beacons 140, which may be disposed in or with various sensors 130 throughout a managed environment to provide navigation services to users in addition or alternatively to navigation services provided to the various user devices 110. In various embodiments, the navigation beacons 130 may include lights that are operated individually or in a collection (e.g., showing a direction to navigate an environment via sequential activation/deactivation patterns), display devices, and speakers. In various embodiments, the navigation services provided to the users may be given via a traditional map overlaid on a floorplan displayed on a user device 110, or may be presented via an augmented reality (AR) interface on the user device 110 that uses locational data and camera data from the user device 110 to overlay the services on a viewed image of the environment.

For example, a mall may have various major exits, major stores, gathering features (e.g., statues, fountains, displays), stairwells, and other points of interest (PI), which may be registered independently of any sensor/beacon, with a single sensor/beacon, or a group of sensors/beacons. The navigation services may be based on the registered PIs to allow for “fuzzy” navigation towards or away from recognizable PIs in addition or alternatively to beacon locations so that a path is calculated from each user's location with respect to the coordinates of the PIs to head towards (e.g., fire exits) and PIs to avoid (e.g., a store). In the event of an evacuation (e.g., due to a fire), a first user may be provided a floorplan with an over laid route to exit the mall, while a second user is provided an AR overlay to follow a route to exit the mall, while a third user may rely of broadcast instructions (e.g., from the beacons 130) to help exit the mall. These navigation services may be provided via GPS, Bluetooth and WiFi beaconing, with the AR services (optionally) providing real-time positioning for navigation.

In various embodiments, the AR services may display one or more arrows over an image of the environment that update a direction that the user should move in to follow the response plan, which are updated in real time as the user's location is updated and as environmental conditions change so that the user can continue following the most up-to-date response plan. Other indicia may be provided to a user via the AR services that indicate not to proceed in a direction, whether to run/walk/crawl, an identity or type of the next PI that the user is navigating towards, whether other users are also proceeding according to response plans (e.g., to assure family members who are separated that other family members are also proceeding according to the response plan, to identify first responders to users evacuating an environment), and the like.

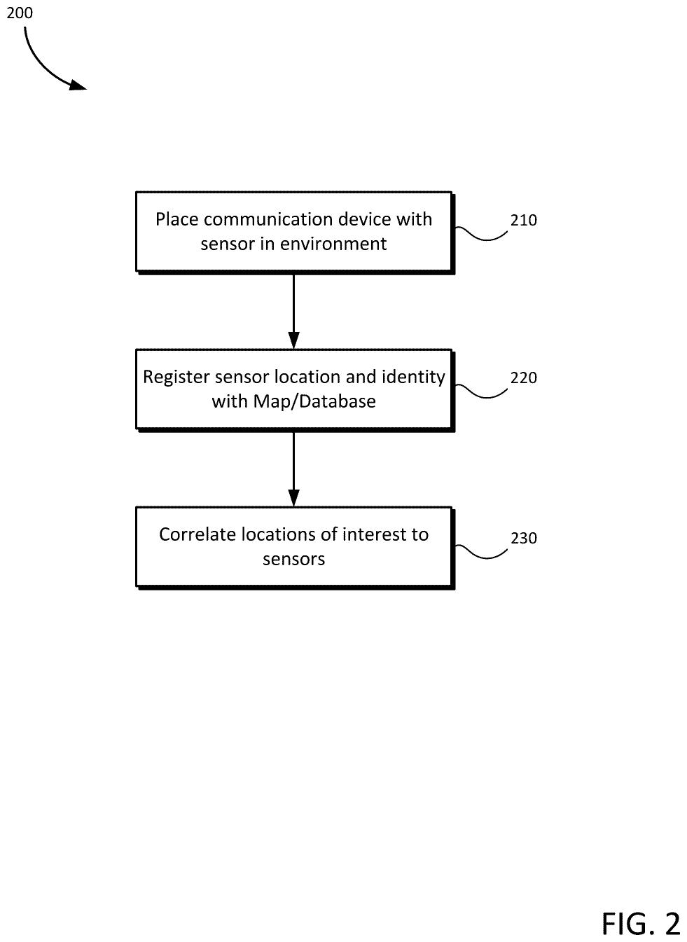

FIG. 2 is a flowchart for an example method 200 of deploying an incident response notification system, according to embodiments of the present disclosure. Method 200 begins at block 210, where an operator places a communication device with a sensor in the environment to monitor. In various embodiments, the operator considers various requirements, regulation, and goals for a project that indicate the locations, categories, and numbers of sensors or instruments to be deployed. The present disclosure contemplates that various projects will have different numbers and types of sensors or instruments deployed to meet the goals for a deployment, and the operator (as a person of ordinary skill in the art) will be able to interpret these goals and requirements to identify the sensors to deploy, and locations to deploy those sensors.

For example, a local building code may specify that one fire detector is to be deployed in each room of a dwelling and one carbon monoxide detector is to be deployed on each floor of a dwelling. Accordingly, an operator may use the layout of the building, the goals of the project, and the local building code to identify where to locate the various fire detectors, carbon monoxide detectors, and other sensors using ordinary skill and creativity.

In various embodiments, depending on the availability of different communications channels in the environment, signaling properties in the environment, and distances of the sensors among one another or a central device used to collect/forward communication among the sensors, the operator may select one or more wireless communications standards for the communication device of the sensor to use. For example, the communication device may use one or more of wired communications, Bluetooth, Wi-Fi, radio protocols, LTE, etc.

At block 220, the operator registers the location and identity of each sensor deployed as per block 210 as part of the incident response notification system with a map/database hosted by a central service. In various embodiments, every sensor has a name or other identifier that is correlated with the location of the sensor in the environment. In various embodiments, the location may be stored as a set of Global Positioning System (GPS) coordinates, layout coordinates (e.g., using a reference frame of a campus, building, or other environment), or other set of coordinates that can identify where the sensors are located in relation to one another and the environment.

In some embodiments, the registered sensors are associated with a public/private encryption key pair with the central service for encrypting status alerts from the sensors. Because the status messages may be relatively simple (e.g., a binary alert/no alert, a timestamp, a device identifier, etc. in a known order/format), messages from the various sensors may be vulnerable to spoofing by malicious parties, even if encrypted. Accordingly, in embodiments that use security-sensitive sensors, registering the location and identity of each sensor may include registering a shared secret or other salting mechanism (preferably a mechanism that changes over time) for each sensor to increase the complexity of the status messages when encrypted and thereby reduce the ability for malicious parties to spoof status messages. Accordingly, the central service can evaluate and determine whether to accept or reject a status message to thereby improve data security for any reported statuses; thereby reducing the likelihood and effectiveness of attacks on the central service or individual sensors.

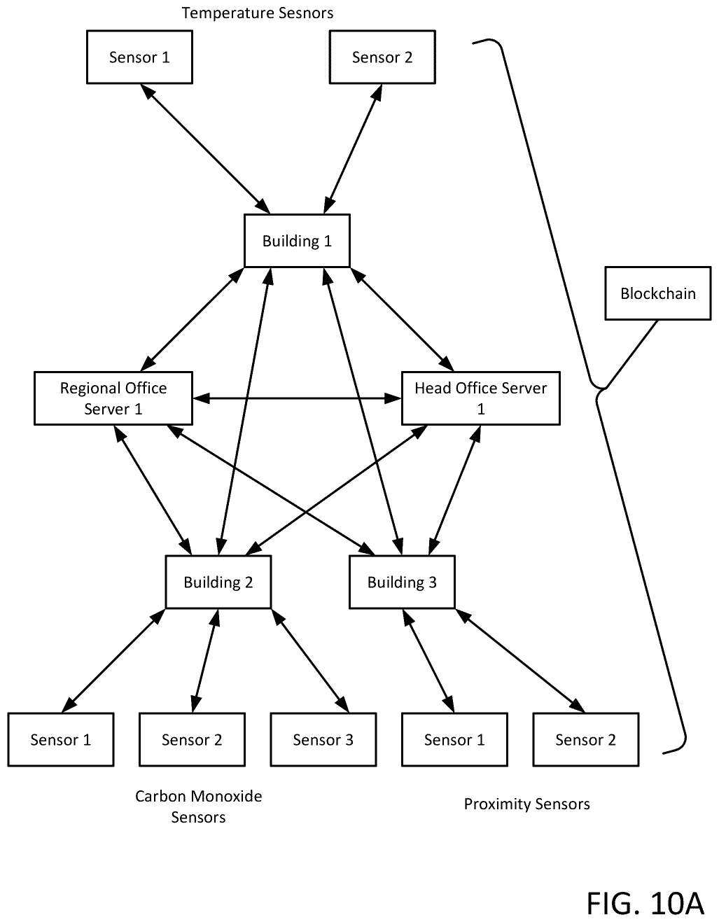

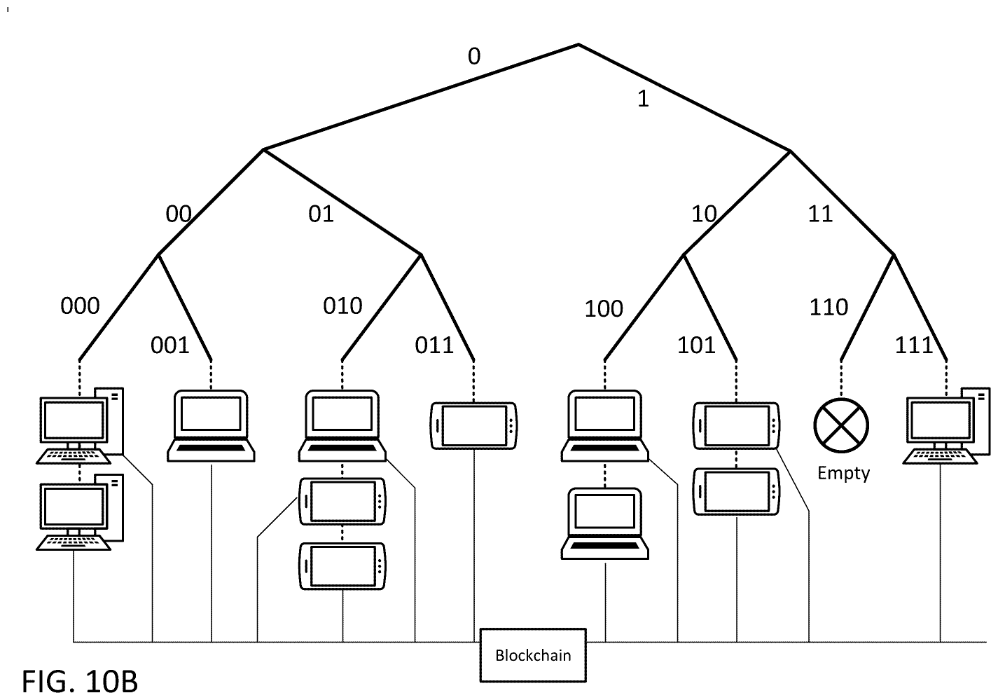

In addition or alternatively to using a client-server model, the system can use various peer-to-peer (P2P) models. Accordingly, depending on the specifications set for the system, an operator can select various models, such as, but not limited to, those included in FIGS. 10A and 10B for a hybrid P2P model or a structured P2P model, respectively, according to embodiments of the present disclosure.

Accordingly, when provided as a distributed system, the various components interact with one another to achieve a shared objective, such as monitoring a cloud of sensors. The system maintains concurrencies in the various distributed components to achieve a shared objective by accounting for the lack of Global Clock and the possibility that independent components can fail independently of one another, such that when a component of one sub-system fails, the entire system does not fail (e.g., in P2P applications). For example, the presently described system can be applied for any architecture which is deployed across different time zones when a distributed application architecture is applied so that, for example when monitoring a border fence spanning across different time zones, or any distributed system in which a failure in one component, will not affect other components.

In various embodiments of the present system, block chain technologies are used to aid in decentralization while maintaining accountability (e.g., providing trust) in the system due to the immutable and peer-approved aspects offered by block chains, particularly when used with web 3.0 applications.

In various embodiments of the present system using a P2P or hybrid P2P architecture, the sensors included in user devices 110 (e.g., cell phones) may be incorporated into a mesh with other sensors 130 deployed in the environment when a user connects that device to the system (e.g., via a web app), to thereby provide additional details on the environment to the system that are localized to the user. In various embodiments, any device having connectivity to a network and a sensor 130 can be integrated into the mesh of sensors 130 used by the present system. Accordingly, the present system may use an Internet of Things (IoT) approach to building a mesh of sensors 130 that are outside of the control of the system, but provide valuable data for the status of the environment. These sensors 130 may go offline and come online outside of the system's control (e.g., due to users connecting/disconnecting devices per user presence/absence in the environment, due to environmental conditions disabling or enabling the associated devices, etc.).

In various embodiments, registering the location and identity of the sensors creates (at the central service) a blockchain or other immutable record for either the environment (e.g., shared among the several sensors), or for each individual sensor in the environment. Accordingly, as the sensors generate alerts, an immutable record of these alerts is recorded so that reviewers can be assured of the integrity of the data. By knowing the time and order of the status reports, the blockchain or other immutable record can be used to identify improperly timed, duplicate, or otherwise spoofed status reports from legitimate reports; thereby reducing the likelihood and effectiveness of attacks on the central service or individual sensors.

Additionally, aside from injection or man-in-the-middle attacks, the system may be designed to avoid or combat distributed denial of service (DDOS) attacks by appropriately scaling the servers used in the central service and/or by selecting a “fail to” status appropriate for the environment (e.g., fail to alerting of an incident when service is interrupted, fail to there not being an incident when service is interrupted).

At block 230, the operator correlates locations of interest to the sensors. In various embodiments, merely knowing the relevant locations of the sensors can be insufficient to generate a response plan to an incident, and the operator therefore correlates additional locational information with the various sensors. For example, knowing that the first through third sensors are located at respective coordinates X+3, X, and X−3, can identify that the second sensor located at coordinate X is between the first and third sensors. However, by correlating that fire escapes are located at each of the coordinates X+3, X, and X−3 with the respective sensors, the incident response notification system can identify a closest available fire escape to a user located at location X−2 and perform other response planning activities that account for the special nature of some locations.

In another example, the location of interest to a sensor may identify a detection range of the sensor. For example, in a security system a motion detector may be physically located at coordinates (X₀, Y₀), but is able to detect motion in an area for coordinates in the range of (X₁, Y₁)-(X₂, Y₂) so that a status report of detected motion can be correlated to the coordinates in the detection range.

In various embodiments, method 200 is performed via a single application that has several different layers of authentication based on user privileges. For example, civil defense personal, defense entities, managers, administrators, base-level user, guest-level users, etc. with different applications can react appropriately per their role in the incident. For example, residents of a building experiencing a fire may be provided evacuation plans that are individualized based on their locations in a building relative to the emergency exits and where the fire has been detected, while firefighters are provided with entry plans that are individualized based on their locations and specialties or assigned roles (e.g., fire dousing, resident extraction) relative to the locations of the fire, access points into the building, and locations of any persons/animals in the building.

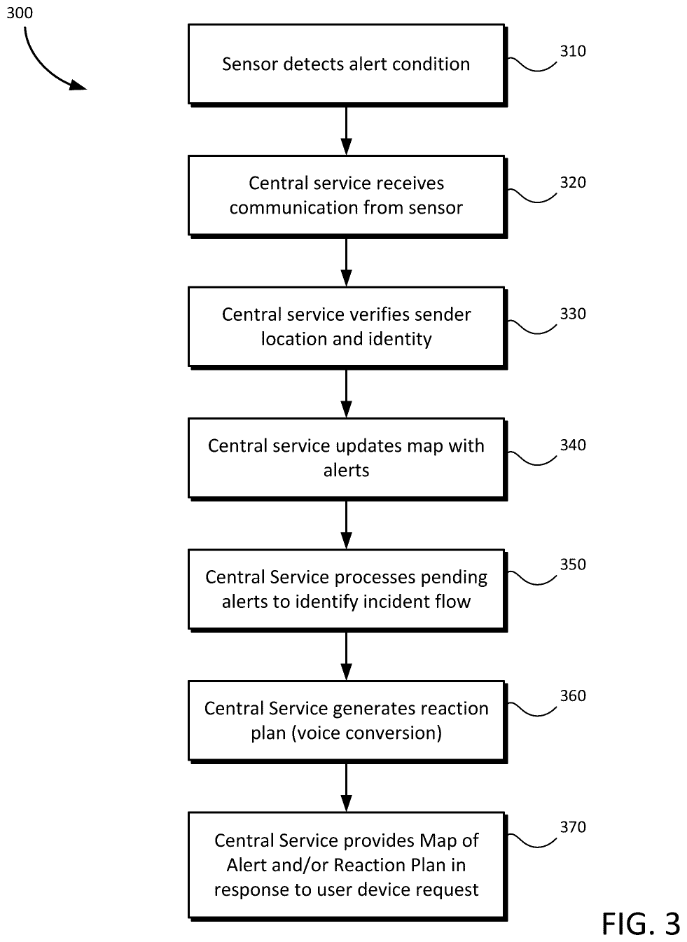

FIG. 3 is a flowchart for an example method 300 of operating an incident response notification system, according to embodiments of the present disclosure. Method 300 begins at block 310, where a sensor detects an alert condition. In various embodiments, different sensors may be triggered to detect an alert condition in response to different conditions. For example, a first sensor may be configured to generate an alert every n seconds to provide a periodic status signal, while a second sensor may be configured to generate an alert every 2n seconds. In another example, a sensor of a smoke detector may be configured to generate an alert in response to particles interrupting a beam of light. The present disclosure contemplates that many different types of sensors with different trigger conditions can be used. In various embodiments, these sensors reports may collect their transmissions at a node before transmission to the central service, such as via a fire panel that collects data from smoke/fire/temperature sensors in a building.

At block 320, the central service receives a communication from a sensor in response to the detected alert condition from block 310. In various embodiments, the sensors, when triggered, communicate through various available communicate channels, and the communication may be received directly or indirectly (e.g., via one or more intermediary devices) by the central service. In various embodiments, central service receives these communications via an interface module that is configured to send and receive communications with various sensors, user devices, and the like via various communications standards that are converted via an API into or from a single standard used internally by the central services.

At block 330, the central service verifies the sender location and identity of communications received per block 320, to identify whether the communication was received from a legitimate sensor and which sensor the communication was received from. In various embodiments, the central service may save all communication from purported sensors (e.g., to log attempted spoofs, either to the record used by the actual sensors or a quarantined record) or may discard communication from sensors that are not verified (e.g., deleting, dropping, or otherwise not storing the communications). In various embodiments, the central service may decrypt the communications, identify whether the communication include a shared secret, challenge the purported sensor, or perform combinations thereof to determine whether the communication has been legitimately received from the sensor. In various embodiments, data received from sensors are processed through software logic or an API and stored in a database or block of a blockchain for committal.

At block 340, the central service updates a database mapping of the environment with the alerts from the sensors. The central service may identify where the alert affects the environment based on the registered location of the sensor in the environment or other correlated locations registered with the sensors (e.g., per method 200 discussed in relation to FIG. 2). In various embodiments, the database may be output via a two-dimensional or three-dimensional map of the environment so that a user can visualized the alerts and statuses reported from the sensors in space. In some embodiments, the users are provided individualized links to receive AR navigation instructions to overlay navigation instructions and environmental data relative to an image of the environment captured by the user device 110. Depending on the application for the sensors, the database and visualization can provide for monitoring of various systems, building, and environments, such as, but not limited to: drainage networks, water networks, chemical networks, guiding systems, border fences, metros, tunnels, fire incident notification systems, or the like and combinations thereof. In various embodiments, this map may be made available to associated applications running on user devices via a “push” from the central services, or may be available on the web via cloud services to user devices that access a website.

At block 350, the central service processes pending alerts to identify an incident flow. The “flow” of an incident, as used herein, refers to the progression of an incident over time. For example, the central service may track a fire's spread over time and the flow of smoke over time by using several readings from different sensors in the environment over time; noting when different sensors are triggered, maintain a triggered status, stop reporting a triggered status, or go offline. Other examples of incident flow include the progression of water, chemicals, persons, animals, or the like throughout or across various points in an environment over a period of time. In some embodiments, the visualization of the incident may include various time-related aspects such as allowing a user to see an animation of the flow of alerts and statuses over time (e.g., to see not only where a fire is present, but how that fire spread over time). In some embodiments, the visualization of the incident flow may include trick-play commands (e.g., fast forward, rewind, speed-up, slow-down, pause, jump) to view the flow in 1:1 timing ratio and flow direction to real time or a different timing ratio or flow direction.

At block 360, the central service generates a reaction plan, which can include visual representations, voice/sound representations, and combinations thereof.

For example, when monitoring an incident of livestock escaping an enclosure, the central service may identify the flow of the incident to identify where the livestock escaped from, and how they have traveled since the escape. These data may be provided to a machine learning model or a rules-based model to identify one or more likely paths that the livestock will travel to in the future (e.g., based on previous escapes, available routes, expected/maximum speeds of the livestock, etc.) to alert responders for where to intercept the livestock and where to repair the enclosure. The reaction plans may be provided to the responders on a map, showing the site for repair and projected heatmaps of likely locations or previous locations where escaping livestock were located. The reaction plan may be provided in conjunction with a visual output of the alerts (e.g., on a shared map showing locations of the livestock via tracking collars, motion detector alerts, etc.).

In another example, when monitoring an incident of a fire in a building, the central service may identify the flow of the incident to identify still-available evacuation plans. These data may be provided to a machine a machine learning model or a rules-based model to identify likely paths for the continued spread of the fire so that persons are directed away from the current location of the fire and away from the expected locations to which the fire will spread. The reaction plans may be provided to responders or evacuees on a map, showing paths for escape, but may also be provided as an output to one or more devices in the building (e.g., the sensors) to provide audio or visual escape cues. For example, a firefighter or other user in possession of a user device accessing the central service may be provided a visual map of where the fire is currently located and expected to spread in the next m minutes, while the sensors in the environment provide audio output (e.g., “proceed to fire escape A”, “come this way”, sequential output of alarm) and/or visual output (e.g., sequential output of light along a pathway of sensors to provide guiding lights towards an exit).

In various embodiments, when the sensors or other devices in the environment provide sequential output for the reaction plan, the output may be “driving or notifying” (e.g., seeking to push away from a location) or “guiding” (e.g., seeking to direct towards a location). For example, consider a hallway with sensors located at points X+1, X+2, X+3, a fire located at point X, and a fire escape at location X+4. When the sensors output a driving sequence of sounds (e.g., to frighten animals away from the fire and towards the fire escape), the sensors located closer to the fire may output an alarm at a greater volume, a longer duration, or combinations thereof than sensors further from the fire. Accordingly, the sensor at point X+1 activates louder/longer than the sensor at point X+2, which activates louder/longer than the sensor at point X+3 to encourage movement towards point X+4 and away from point X. In contrast, when providing a guiding sequence of sounds (e.g., playback of “escape this way”), the sensors located closer to the fire escape may output the sounds at greater volume than sensors located closer to the fire, more frequently than sensors located closer to the fire, in a pattern towards the fire escape, or combinations thereof. Accordingly, a sensor at point X+1 may playback at time T₁, the sensor at point X+2 at time T₂, and the sensor at point X+3 at time T3 (where T₁−T₂−T₃), where the playback is progressively louder closer to point X+4.

At block 370, the central service provides the map of alerts and/or the reaction plan to a user device in response to receiving a request from the user device. In various embodiments, map of alerts and the reaction plan may be provided in conjunction with one another (e.g., on a shared map showing locations of alerts and how to react to those alerts), or separately from one another. In some embodiments, the outputs are provided via a website hosted by the central service that the user device access through a web browser, or via an API or specific program executing on a user device to receive and interact with the outputs.

In some embodiments, the central service may push the outputs to one or more devices (e.g., in response to a preference setting requesting pushed alerts/reaction plans) so that a user can request (before an incident is detected) that alerts and reactions plans be provided to one or more devices. For example, the central service may push the reaction plan to one or more sensors in the environment to alert user who do not have user devices otherwise receiving the reaction plan for how to respond to the incident.

Because the central service continues to receive alerts from the sensors as time progresses, and knows where the various sensors are located in the environment, the central service can update the reaction plan (and the output thereof) as conditions change and the flow of the incident progresses. Accordingly, method 300 may be performed in a loop; with the map or reaction plan (and output thereof) continuously being adjusted as conditions change.

In various embodiments, the central service exchanges coordinates with various navigation beacons to output the reaction plan to navigation beacons in addition or alternatively to user devices. The activation or deactivation of the navigation beacons may be controlled by the central services for the duration of the incident, such that the navigation plans for responding to an incident (e.g., guiding users away from dangerous conditions, guiding users towards control interfaces to address an incident) may be continuous updated and change how the users are encouraged to proceed in the environment. For example, a user responding to an incident of a damaged fence and escaped livestock may first be directed via navigational beacons to a circuit breaker box to attempt to restore power to an electric fence (or deactivate power to allow for repairs) and is then directed to the locations of any escaped livestock after completing the task at the breaker box.

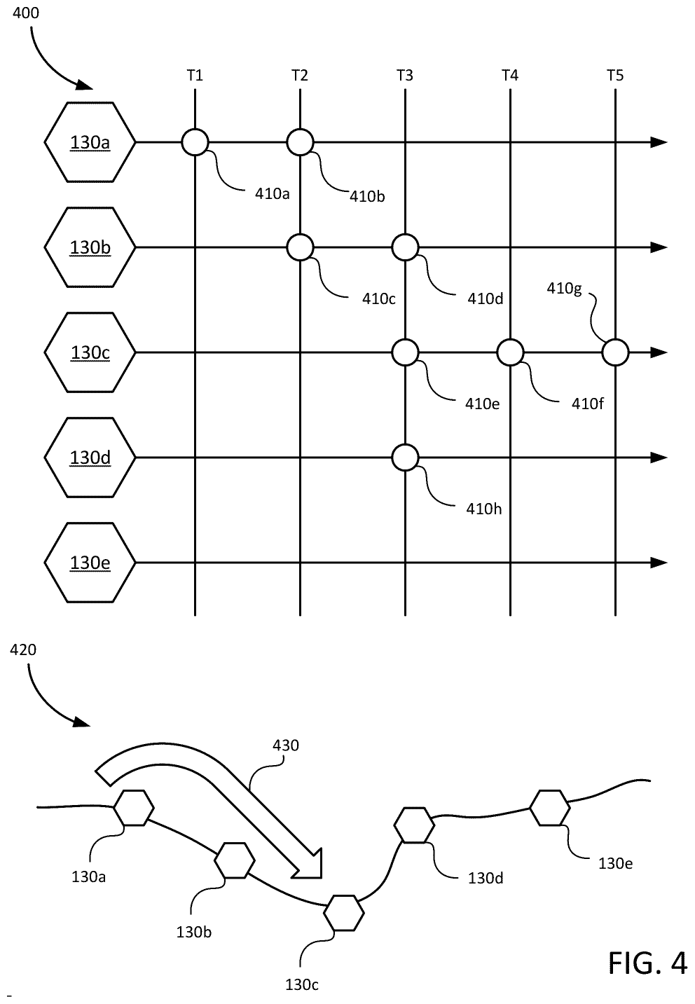

FIG. 4 illustrates a time chart 400 of operating an incident response notification system with a corresponding environment 420, according to embodiments of the present disclosure. As shown, the time chart 400 displays alerts 410a-h (generally or collectively, alerts 410) associated with various sensors 130a-e at different times T₁-T₅. In various embodiments, times T₁-T₅ may be evenly/constantly distributed (e.g., ΔTₓTₓ₊₁=ΔT_{y}T_{y+1}) or unevenly/variably distributed (e.g., ΔTₓTₓ₊₁≠ΔT_{y}T_{y+1}). For purposes of the present example, each alert 410 relates to a detected presence of water, but other alerts 410 and combinations of multiple types of alerts 410 are contemplated by the present disclosure.

In the present example, water flows into a culvert, pond, or other depression that is part of a monitored drainage network, as shown by the action arrow 430 in the environment 420. The first sensor 130a identifies the presence of water at times T₁ and T₂, and ceases to identify the presence of water at times T₃-T₅; indicating that water flowed over the first sensor 130a between times T₁-T₂. Similarly, the second sensor 130b identifies no water present at time T₁, the presence of water at times T₂-T₄, and ceases to identify the presence of water at times T₄-T₅; indicating that water flowed over the first sensor 130a between times T₂-T₃. The third sensor 130c identifies the presence of water at times T₃-T₅; indicating that water is present in the depression in the environment 420 starting at time T₃ and continuing to (and potentially past) time T₅.

Using the collected data from the alerts 410 at the times that the associated sensors 130 generated those alerts, and the known locations (and sensing ranges) of the sensors 130, the systems and methods of the present disclosure can determine a flow of events. In the present example, the direction and duration flow of water into the depression (and potential depth thereof once settled) can be identified from the timing chart 400. Accordingly, by knowing the flow of events (e.g., water into the depression from the first sensor 130a towards the third sensor 130c), the systems and methods of the present disclosure can provide a reaction plan based on those events. For example, an evacuation plan that directs persons to move away from the third sensor 130 in the direction away from the first sensor 130a (where the water is coming from).

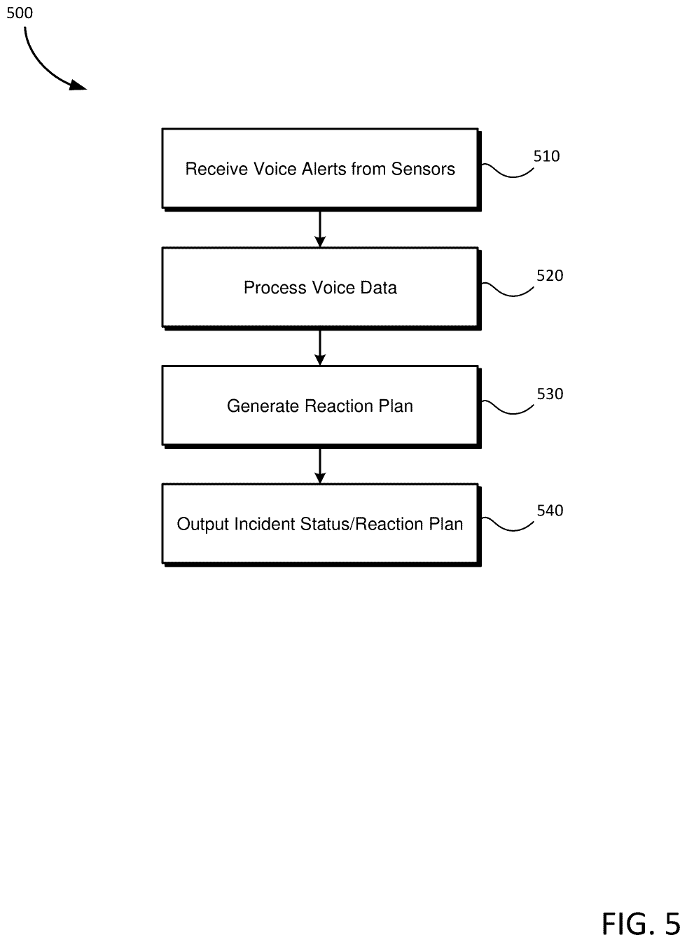

FIG. 5 is a flowchart of an example incident response method 500, according to embodiments of the present disclosure. Method 500 begins at block 510 where voice alerts are received from the sensors. In various embodiments, the sensors may be triggered to collect voice alerts in response to detecting a trigger phrase or the sensor activating due to an environmental condition. For example, a personal assistant (such as the ALEXA® smart home apparatus, offered by Amazon Technologies, Inc.) may be configured to begin collecting voice data in response to a user uttering the name of the device, while a voice recorder in a smoke detector may be configured to begin collecting voice data in response to smoke particulates interrupting a beam (e.g., detecting smoke).

In various embodiments, the central service can directly receive these voice data from the sensors or indirectly receive these data from a third-party transcription service that converts the utterances into words, intents, and meanings on behalf of the sensors. In embodiments that the central service directly received the voice data from the sensors, the central service may locally process the voice data, or may send the voice data to a third-party transcription service to return processed voice data for the central service to use. Accordingly, method 500 may iterate block 510 one or more times for a given set of voice data.

At block 520, the central service processes the voice data for inclusion into the database with other status data. In various embodiments, the central service extracts various data points related to metrics tracked by other sensors in the deployment environment (e.g., users stating that there is smoke in the environment when the environment includes smoke detector sensors) or that is not tracked by other sensors in the deployment environment (e.g., users stating that N persons are located in a room that lacks a camera or other sensors to identify a number of persons in the room). In various embodiments, processing the voice data may include extracting key words from the transcript or the utterances that can be used to fill in the data fields of the

At block 530, the central service generates a reaction plan using the processed voice data and the sensor data. The central service uses the data (voice and sensor) to identify statuses in the environment (e.g., where smoke is located, where persons are located). Various rules-based or machine learning models may be used to identify the status or forecasted status of an incident that can be communicated to the users in addition to or alternatively to a reaction plan. Using the data in the database, the central service generates one or more reaction plans to the incident (e.g., where emergency personnel are directed to, where persons are directed to evacuate towards/away from).

In various embodiments, the reaction plan can include voice instructions that are sent to designated sensors or user devices, which may include prompts for a user to provide voice data. These voice prompts may be generated by the central service on-the-fly, preloaded in an application executing on the user device or sensor, or generated on behalf of the central service by a third-party voice service. For example, the reaction plan may include one or more devices outputting a voice command requesting anyone in a room to identify themselves, whether anyone in the room is hurt, or to provide other voice alerts that can be used to provide further information relevant to the incident.

At block 540, the central service outputs the incident status and/or reaction plan generated from the voice data and the other sensor data. In various embodiments, the environmental data related to the incident or the reaction plan is pushed to one or more devices, such as sensors or on-call devices. In various embodiments, the environmental data related to the incident or the reaction plan is provided to one or more devices in response to a request from such a device, such as a serving a webpage showing the data or plan(s). These outputs may be dispersed via APIs or in published to a website or other publicly accessible data format that a user device requests via a web browser, or the like.

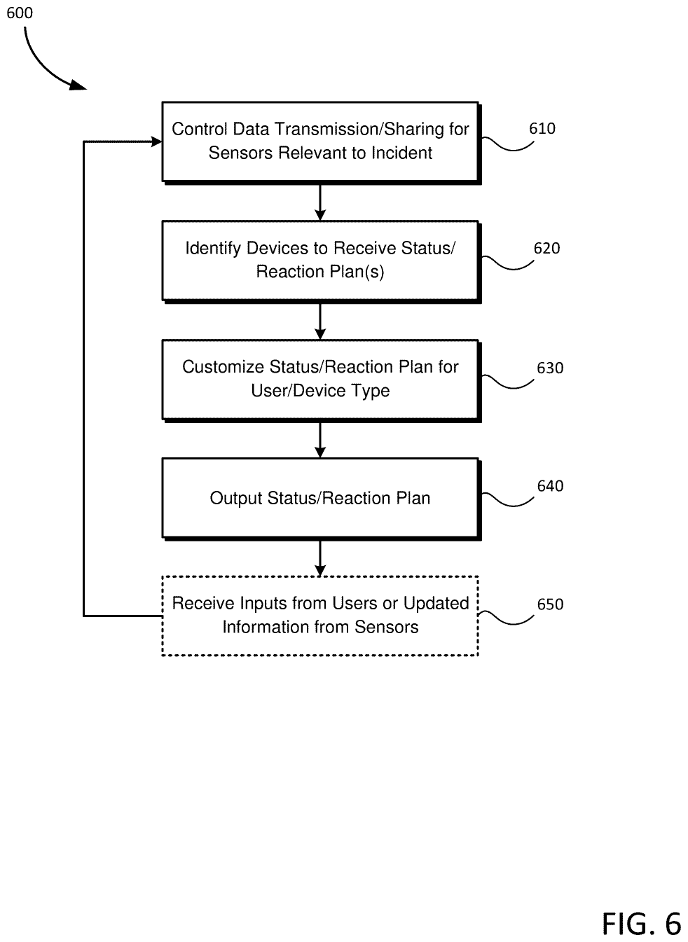

FIG. 6 is a flowchart of an example method 600 for customizing an incident response, according to embodiments of the present disclosure. Method 600 begins at block 610 where the central service controls data transmission and sharing for the sensors that are relevant to an ongoing incident.

In various embodiments, various sensors disposed in an environment may be provided for alternative purposes (e.g., a motion detector for detecting presence in a given area, a smoke detector for detecting smoke in a given area, a thermometer for detecting temperature in a given area). Accordingly, depending on the type of incident occurring, various sensors may offer relevant data for responding to an ongoing incident or may not offer relevant data. Additionally, as persons enter or leave portions of the environment, the data from various sensors may increase or decrease in relevance. Therefore, to conserve processing power and available bandwidth for transmitting updated data and reaction plans based on the data, the central service may transmit commands to various sensors to activate, deactivate, increase transmission rates, or decrease transmission and data reporting rates for a predefined amount of time or the duration of the incident.

For example, a thermostat may generally report temperature data in a building to the central service once every X minutes during normal operation, but may be controlled to provide temperature data once every X/10 minutes in the event of a fire in the building (e.g., to track spread and identify areas of safe passage), or once every 10X minutes in the event of a flood or water leak in the building (e.g., when the temperature is less relevant to detecting the presence of water). Various incident profiles may be used to identify what data are relevant to various identified types of incidents to respond to. In various embodiments, the sensors may be configured to continue collecting data at a constant rate, but vary how often the data are transmitted to the central service (e.g., increasing or decreasing the data reporting rate), or may vary both how often data are collected and transmitted.

Similarly, as more or fewer user devices are located within different portions of the environment in which the ongoing incident is occurring (or is predicted to occur), the availability of bandwidth to communicate with those user devices may be in higher or lower demand. Accordingly, the central service may alter the data reporting rate of the sensors in the environment based on the number of sensors or user devices, or may alter an update rate for providing updated status reports or reaction plans to the user devices, or may alter the amount of data included in the status reports of reaction plans to manage and conserve bandwidth in the environment.

In various embodiments, various sensors disposed in an environment may be provided under the control of various parties, some of whom may not (or not yet) be affected by the incident. However, by using a shared API for reporting data to the central service, the central service may use the data (when relevant) to an incident among several parties. For example, an industrial area may include various factories, warehouses, and the like under the control of different operators who use different sensors, in which the various operators do not want to share data (for privacy reasons) with other parties with each other during normal operations. However, during an environmental incident (e.g., a flood, fire, chemical spill/release, or other incident) data from one operator may be used with data from other operators when relevant to improve the overall response plan.

For example, if a first operator of a chemical plant accidentally vents a harmful chemical, an environmental incident may be detected via various sensors in the chemical plant. In response to this incident detection, the central service may access data from wind speed/direction sensors operated by the first operator and other nearby operators (e.g., within a predefined distance of the chemical plant) to identify parties downwind of the chemical plant. Using the data from the several parties allows the central service to better gauge wind conditions than only using data provided by the first operator and so that potentially affected persons who may or may not work at the chemical plant can be promptly notified with a reaction plan. The central service may use various event profiles to identify what sensors offered by different parties are “relevant” to a given incident that are controlled by other operators and only collect and share data from relevant sensors; thereby preserving data privacy. For example, the wind speed data from anemometer operated by a second operator of a warehouse nearby the chemical plant may be used in response to the venting incident from the chemical plant, but motion sensor data from sensors operated by the second operator (e.g., for security purposes to detect unauthorized entry) may remain unused or used in a limited scale to identify potential persons to provide a reaction plan to.

At block 620, the central service identifies devices to receive status or reaction plans. In various embodiments, the central service may be triggered to identify which devices are to receive the reaction plans in response to receiving a query from a device for such a plan or an alert from a sensor indicating that an environmental condition has been detected that necessitates a reaction plan being distributed. For example, a sensor of a smoke detector in a building may detect smoke and alert the central services, which then identifies the user devices (and other sensors) in the building or near the building to push a reaction plan to.

In various embodiments, the identified devices can include those registered with a given location where the incident is detected as well as various devices that are not registered with that location, but are determined to be within a predefined distance of that location. For example, residents of an apartment complex may be interested in learning of a fire at the apartment complex regardless of whether those residents are at home or away from home, and register devices or accounts (e.g., for use with multiple devices) with the central service to receive appropriate updates. Continuing the example, visitors to the apartment, who are not registered as being consistently interested in updates, may receive status and reaction plans when physically present at the apartment complex, but not receive status and reaction plans when located elsewhere. These plans may be provided as set forth in block 640.

At block 630, the central service identifies the device type, the user type, or both, to determine how to customize the delivery of the status/reaction plan for the particular user. In various embodiments, one reaction plan is generated for the environmental condition from which various customized plans are generated, including one or more sub-sets of the total plan. These sub-sets of the total plan offer individualized versions of the plan, which may omit extraneous details for the associated user (e.g., avoiding confusion, reducing the amount of data needed to be transmitted), and may highlight various other details in a way that the individual user may readily consume and understand via an associated user device or other delivery means.

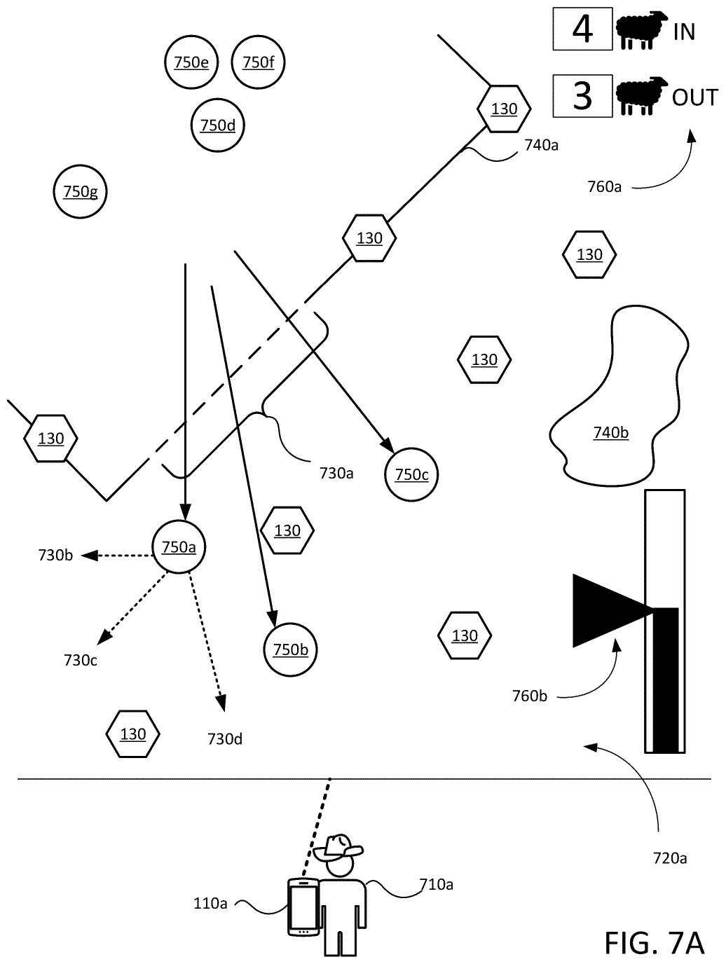

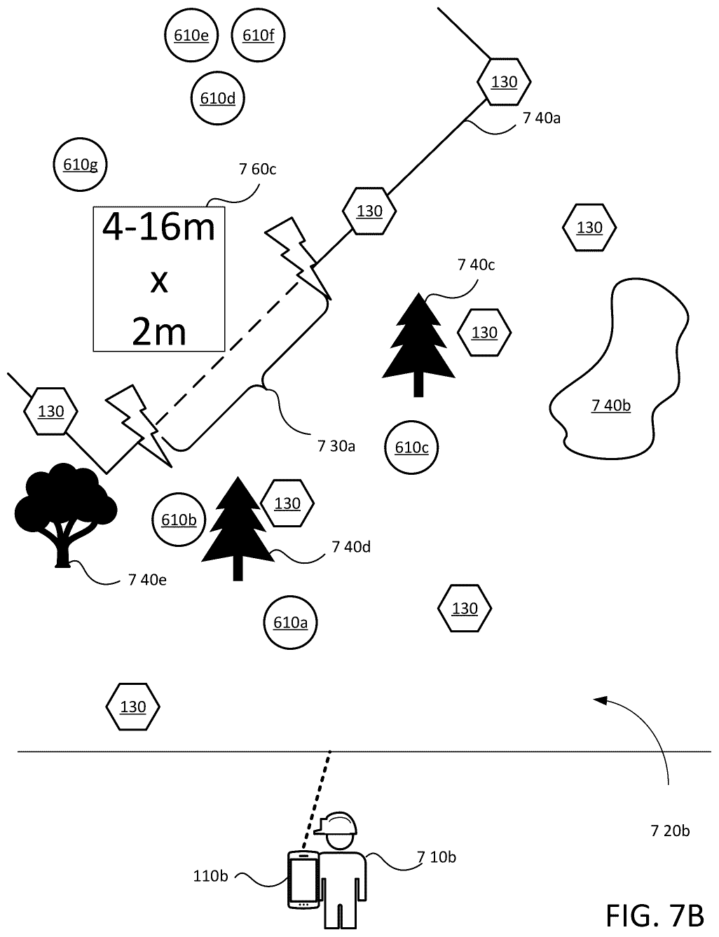

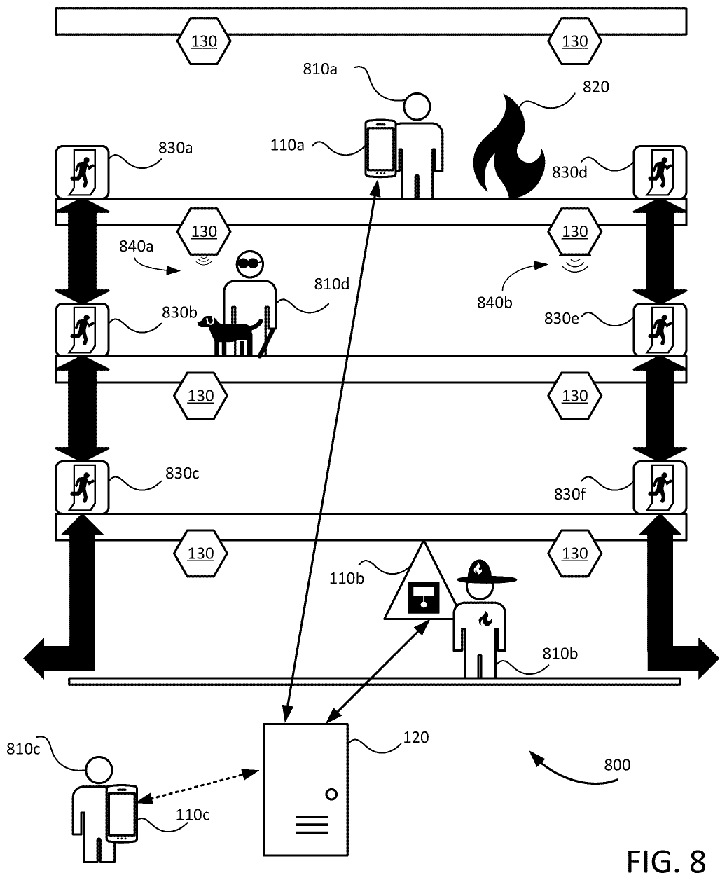

In various embodiments, the graphical user interface (GUI) on the user's device is populated with the individualized of the reaction plan or the collected data particular to the formfactor of the receiving device or information deemed most relevant to the particular user. FIGS. 7A and 7B illustrate one example of different users being provided with different information in respective GUIs for the same reaction plan for the same incident. FIG. 8 illustrates another example of the central service interacting with different users in different ways.

At block 640, the central service outputs the incident status and/or reaction plan generated and customized for the various users. In some embodiments, the whole-plan may be reviewable by a supervisory user, but the individualized and customized status/reaction plans distributed to the affected users to thereby reduce the amount of data needed to be conveyed to individual users (improving network conditions in a potentially congested signaling environment) and focusing responses and adherence to the plan by the individual users. In various embodiments, the environmental data related to the incident or the reaction plan are pushed to one or more devices, such as sensors or on-call devices. In various embodiments, the environmental data related to the incident or the reaction plan is provided to one or more devices in response to a request from such a device, such as a serving a webpage showing the data or plan(s).

At block 650, the central service receives inputs from users or updated information from the sensors in the environment and for the locations of the users in the environment. For example, the incident flow may affect different users at different times, or progress over time according to or contrary to a predicted flow. For example, different persons may follow (or not follow) a proposed response plan at various speeds (e.g., faster than expected, slower than expected, within an expected window of compliance), which may result in the central service needing to update the individual response plans accordingly. Additionally or alternatively, human intervention may accept, reject, or update a response plan or affect how a response plan is implemented, such as an evacuation plan that may proceed in a first phase (awaiting first responders to arrive) and a second phase (once first responders have arrived). For example, the central service may identify a first plan and an administrative user may accept or reject that plan; potentially substituting a new plan or modifications to the first plan to thereby create a second plan that should be disseminated to various user devices.

Method 600 then returns to block 610 and block 620 to identify whether additional data sources can supply relevant data for addressing the incident and new devices (or existing devices) to provide updates to the plan or changing conditions of the environmental incident.

FIGS. 7A and 7B illustrate example graphical user interface (GUIs) 700a-b related to the same environmental incident that are provided with different data highlighted for the use of different users, according to embodiments of the present disclosure. As illustrated, a first user 710a in FIG. 7A and a second user 710b (using respective user devices 110a-b) are provided with customized reaction plans via corresponding GUIs 720a-b to respond individually to the same environmental incident of a broken livestock fence.

The first GUI 720a shown in FIG. 7A is provided to the device 110a of a first user 710a identified as a rancher or farmer. The GUI 720a is populated with a map of the area in which the incident has occurred, and includes the relative position of various permanent features 740a-b (generally or collectively, permanent features 740) of the environment, the sensors 130, predictive indicators 730a-d (generally or collectively, indicators 730), mobile features 750a-g (generally or collectively mobile features 750), and GUI elements 760a-b (generally or collectively, GUI elements 760).

In contrast to the rancher's GUI 720a in FIG. 7A, the second GUI 720b shown in FIG. 7B is provided to the device 110b of a second user 710b identified as a construction worker. The GUI 720b populated with a map of the area in which the incident has occurred, and includes the relative position of various permanent features 740a-b (generally or collectively, permanent features 740) of the environment, the sensors 130, predictive indicators 730a-d (generally or collectively, indicators 730), mobile features 750a-g (generally or collectively mobile features 750), and GUI elements 760a-b (generally or collectively, GUI elements 760), but some of the elements shown differs between the two GUIs 720.

For example, because the rancher is more interested in containing or returning livestock to containment relative to the construction worker, the first GUI 720a is provided with a predictive indicator 730a of where a permanent feature 740a of a fence may be breached, and predictive indicators 730b-d for where various ones of the escaped livestock are believed to be headed. Additionally, the rancher is provided with GUI elements 760a that provide for a count of the variously located livestock and GUI elements 760b that allow for the playback of where the livestock are believed to be headed or where the sensors 130 previously located the livestock, which are omitted from the construction worker's GUI 720b.

In this example, because the construction worker is more interested in repairing or restoring functionality to the fence 740a relative to the rancher, the second GUI 720b is provided with a predictive indicator 730a of where a permanent feature 740a of a fence may be breached and additional indicators for the permanent features 740c-e that may have fallen to damage the permanent feature 740a of the fence or otherwise may impede repairing the fence.

As will be appreciated, depending on the roles and interests of the user relative to the environmental incident, and the capabilities of the associated user device 110, more or fewer interface elements may be provided to the user. Accordingly, the same data may be used by the central service to provide different users with different GUIs 720, where data not pertinent to a given user's responsibilities or interests in the environmental incident are not transmitted to those users. In various embodiments, the user device 110 may locally assemble/format the GUI 720 from data provided from the central service, or may be provided the GUI 720 from the central service.

FIG. 8 illustrates a scenario 800 of an environmental incident in which the described central service 120 generates and implements a response plan, according to embodiments of the present disclosure. In the illustrated scenario, four users 810a-d (generally or collectively, users 810) with different roles or relationships to the incident are shown, but the described central service 120 is contemplated as working with more or fewer users 810 at any given time for various environmental incidents.

As illustrated, a first user 810a is located on a third floor of a building in which an environmental incident of a fire 820 has been detected by the various sensors 130 located throughout the building. The first user 810a is associated with a first user device 110a, which is in communication with the central service 120 (e.g., via WiFi, cellular service, wired telephony or networking services, or other communications formats known to those of skill in the art). The building is shown with several exits 830a-f (generally or collectively, exits 830) through the stairwells of the building by which the various persons in the building may evacuate or firefighters may enter to combat the fire 820 and look for persons trapped thereby.

A second user 810b of a firefighter is shown on the first floor of the building and has access to a second user device 110b of a fire control system for the building, which is also in communication with the central service 120 (e.g., via WiFi, cellular service, wired telephony or networking services, or other communications formats known to those of skill in the art). In various embodiments, the fire control system may be in communication with the various sensors 130 disposed throughout the building (e.g., via wired or wireless communication means) as well as other systems within the building (e.g., sprinklers, air moving systems, elevators, escalators, emergency lighting systems, etc.).

In various embodiments, the central service 120 may deem various users 810 to have different roles in responding to the environmental condition, and may provide different plans or different levels of information to these different users 810. For example, emergency personnel (such as a firefighter, like the second user 810b) may be provided with a plan that directs those personnel towards the environmental condition while other persons are directed away from the environmental condition.

These plans may change over time as the flow of events occurs and as persons enter and exit the environment. For example, at a first time, persons on the third floor may initially be directed to evacuate the building by taking the stairway at the fifth exit 830e and the sixth exit 830f so as to avoid clogging the stairway at the first through third exits 830a-c that persons on the third floor are directed to use. However, at a second time (after the first time), persons on the third floor may instead be directed to use the stairway at the first through third exits 830a-c, such as when all persons from the third floor have evacuated, the fire 820 has shifted, or emergency response personnel have arrived (e.g., reserving the use of the fourth through sixth exits 830d-f for

A third user 810c is shown outside of the building, and is associated with a third user device 110c, which is (optionally) in communication with the central service 120 (e.g., via WiFi, cellular service, wired telephony or networking services, or other communications formats known to those of skill in the art). The central service 120 may determine the relative location of the various users 810 according to readings from the sensors 130 and reported location information from the user devices 110, and determine the registration statuses of the various users/devices based on a referential table or other data structure that assigns roles to the various users 810 identified in and outside of the environment.

For example, if the third user 810c is a passerby, despite having a user device 110c capable of communicating with the central service 120, the central service 120 may refuse communications from the third user 810c (e.g., not send push messages or respond to queries from the third user 810c aside from (potentially) telling the third user 810c that detailed responses are purposely not being provided to the third user 810c at this time) to preserve bandwidth in the local environment for communicating with the other users 810 who are judged to be more immediately affected by the environmental incident.

Accordingly, some users 810 who are determined to be neither located in the environment affected by the incident nor associated by the central service 120 with the environment may be provided a refusal reaction plan that actively prevents that user (or an associated device) from receiving information from the central service 120 or making queries to the central service 120 for a predefined amount of time, until the user 810 is at least a predefined distance away from the environment (e.g., to conserve local transmission bandwidth near the environment), or until the status of the user 810 changes (e.g., the user 810 is identified as being associated with the environment by the central service 120 by providing user credentials as a responder or a resident of an affected environment, the location where the user 810 is located is predicted to be in the flow of the incident, a new incident is detected, etc.).

In another example, a third user 810c who is registered with an environment in which an incident has been detected, but who is not currently within a predefined range of that environment may be sent an alert by the central service 120, but not a reaction plan. For example, a resident of a building that is affected by a fire 820 who is away from the building may be provided by the central service a notice of the fire 820 and instructions to not enter the building.

A fourth user 810d is shown inside the building, but not associated with a corresponding user device 110. In various embodiments, the fourth user 810d may not have possession of an appropriate user device 110, may have a user device 110 that is not in communication with the central service 120 (e.g., in a deactivated mode, in a signal-free or “airplane” mode, in a region that blocks communication with the central service 120, etc.), or may have lost possession of an appropriate user device 110. In various embodiments, when the sensors 130 detect a user 810 and do not detect a corresponding user device 110 for that user, the sensors 130 that include output hardware (e.g., speakers, lights, screens, etc.) may output the response plan to any such users 810. For example, to direct persons to a given stairwell in the building, the sensors 130 may output a first direction 840a and a second direction 840b that variably indicate the response plan to the user 810.

In some embodiments, the fourth user 810d is a non-human user, such as a pet or service animal, which may be directed via sonic alerts, such as ultrasonic noise or pre-trained command signals. For example, to direct pets or livestock in a given direction, ultrasonic noise of varying volumes may be used to scare or herd the animals to flee in a defined direction. In another example, the command signals may use wordless tones or words that the animals have been trained to respond to in a predefined manner (e.g., “a safe to approach” tone sequence, a worded command of “come” or “stay”). In various embodiments, the noise or command signals may be output in frequencies outside of human hearing so as to not distract from sonic alerts given in the audible range for humans to human users 810 (e.g., klaxons, sirens, recorded or AI generated worded commands).

As will be appreciated, the central service 120 coordinates the reaction plan among the various types of users 810, and may periodically update the reaction plan based on updated locations of users of various roles, changing event conditions, commands from users 810 to modify the plan, identifying whether users 810 are following the plan (and at what speed/degree the plan is being followed), and combinations thereof. For example, although an initial plan may direct a second user 810b of a firefighter to ascend the stairway from the sixth exit 830f to the fourth exit 830d to fight the fire 820, if a fourth user 810d on the third floor is identified as immobile or not following an evacuation plan identified by the central service 120, the central service 120 may update the plan for the second user 810d to rescue the fourth user 810d before fighting the fire 820.

By allowing for selective and customizable interaction with various persons, both registered and unregistered with a given location, and various persons, both affected and unaffected by the environmental incident, the central service 120 can provide a universal reaction plan services. These universal reaction plan services improve how various persons effectively respond to various environmental incidents. Although the example given with respect to FIG. 8 is presented as a fire 820 in a building, the present disclosure contemplates that various other environmental incidents, may be managed and that operations can be expanded across separately managed environments (e.g., a first building managed by a first party and a second building managed by a second party).

Although the reaction plans are provided to users 810 (human and otherwise) to choose whether to perform as advised, and may include instructions that are variously formatted for the different users 810. The central service 120 therefore is not employed to manage personal behavior or relationships or interactions between people per se, and indeed accounts for users 810 not following the plans provided thereto (whether ignoring, not receiving, acting contrary to, etc.). Instead, it will be appreciated that the operations of the central service 120 are technical in nature and provide technical improvements to the operation of the overall system. The improvements discussed herein solve technical problems adjacent to the organization of human activities in the collection and processing of sensor data, generation and updating of reaction plans, and controlled transmission of reaction plans. These improvements provide for a generalized or universalized service platform so that more users 810 can be provided the plans in the event of an environmental incident without requiring such users 810 to be pre-registered or to even be in possession of a user device 110 and that such plans can be promptly delivered (and sensor data received to update such plans) when bandwidth for delivery of such plans be at a premium may be less available due to communications needs in responding to the environmental incident.

FIG. 9A illustrates a computing device 900, as may be used in providing user devices 110, a central service 120, or sensors 130, according to embodiments of the present disclosure. The computing device 900 may include at least one processor 910, a memory 920, and a communication interface 930. FIG. 9B-9C illustrate examples of various sensors 940 and input/output devices 950 as maybe included in or in communication with various computing devices, according to embodiments of the present disclosure.

The processor 910 may be any processing unit capable of performing the operations and procedures described in the present disclosure. In various embodiments, the processor 910 can represent a single processor, multiple processors, a processor with multiple cores, and combinations thereof.

The memory 920 is an apparatus that may be either volatile or non-volatile memory and may include RAM, flash, cache, disk drives, and other computer readable memory storage devices. Although shown as a single entity, the memory 920 may be divided into different memory storage elements such as RAM and one or more hard disk drives. As used herein, the memory 920 is an example of a device that includes computer-readable storage media, and is not to be interpreted as transmission media or signals per se.

As shown, the memory 920 includes various instructions that are executable by the processor 910 to provide an operating system 922 to manage various features of the computing device 900 and one or more programs 924 to provide various functionalities to users of the computing device 900, which include one or more of the features and functionalities described in the present disclosure. One of ordinary skill in the relevant art will recognize that different approaches can be taken in selecting or designing a program 924 to perform the operations described herein, including choice of programming language, the operating system 922 used by the computing device 900, and the architecture of the processor 910 and memory 920. Accordingly, the person of ordinary skill in the relevant art will be able to select or design an appropriate program 924 based on the details provided in the present disclosure.

The communication interface 930 facilitates communications between the computing device 900 and other devices, which may also be computing devices as described in relation to FIG. 9A. In various embodiments, the communication interface 930 includes antennas for wireless communications and various wired communication ports. The computing device 900 may also include or be in communication, via the communication interface 930, one or more input devices (e.g., a keyboard, mouse, pen, touch input device, etc.) and one or more output devices (e.g., a display, speakers, a printer, etc.).

The communication interface 930 may be used to communicate with other devices such as sensors 940, input/output devices 950 (e.g., lights, speakers, sirens), and one or more networks 960 that are organized by various communication standards, which may include one or more public and/or private networks via appropriate network connections via the communication interface 930. Various examples of the sensors 940 and input/output devices 950 that may be integrated with the computing device 900 are shown in FIGS. 9B-9C. It will also be recognized that software instructions may also be loaded into the memory 920 from an appropriate storage medium or via wired or wireless means using the communications interface 930.

In particular, FIG. 9C illustrates various examples of 5G IoT sensors and LTE-M or NB-IoT sensors. 5G IoT sensors leverage the capabilities of the fifth-generation (5G) cellular network technology for IoT applications. 5G offers faster data rates, lower latency, and increased capacity compared to previous wireless technologies. These sensors are designed to take advantage of the high-speed and low-latency capabilities of 5G networks. 5G IoT sensors enable real-time applications, high-definition video streaming, and ultra-reliable communication in underground or metro environments.

Some non-limiting examples of 5G IoT sensors that can be used in various applications, including underground or metro environments, include: 1) Environmental Sensors that can monitor air quality, temperature, humidity, and other environmental parameters to ensure safe and comfortable conditions in underground or metro areas; 2) Vibration Sensors that detect and measure vibrations, allowing for monitoring of structural health and detecting potential issues in tunnels or metro infrastructure; 3) Sound Sensors that can be used for noise monitoring in metro stations or tunnels to ensure compliance with noise regulations and identify potential noise-related issues; 4) Surveillance Sensors that provide high-definition video streaming, facilitating real-time monitoring and ensuring the safety of underground or metro areas; 5) Gas Sensors that detect the presence of hazardous gases, such as carbon monoxide or methane, in underground or metro environments to ensure the safety of workers and passengers; 6) Asset Tracking Sensors that are used to track assets, such as vehicles, equipment, or packages, in an underground or metro setting to improve logistics and ensure efficient operations; 7) Crowd Monitoring Sensors that use video or infrared technology to monitor crowd density and movement in metro stations for security and crowd management purposes; 8) Smart City Sensors that monitor and manage various aspects of urban environments, such as air quality sensors, noise sensors, parking sensors, waste management sensors, and traffic sensors; 9) Industrial IoT Sensors that monitor machinery performance, track inventory, manage supply chain logistics, and optimize energy consumption in industries like manufacturing and logistics; 10) Agricultural IoT Sensors that enhance the capabilities of sensors for soil moisture monitoring, crop health monitoring, livestock tracking and monitoring, weather stations, and automated irrigation systems; 11) Healthcare IoT Sensors that enable remote patient monitoring, wearable health devices, telemedicine applications, advanced medical imaging, and real-time asset tracking in hospitals; and 12) Smart Home Sensors for home security systems, energy management systems, smart appliances, and home automation devices.

LTE-M (Long-Term Evolution for Machines) Sensors are a cellular IoT technologies that are compatible with 4G and 5G networks. These sensors are specifically designed for IoT applications, and can provide enhanced coverage, longer battery life, and improved device density. There are numerous LTE-M sensors available in the market designed specifically for machine-to-machine communication and IoT applications. Some non-limiting examples of LTE-M sensors that can be used in various applications, include: 1) Environmental Sensors that measure parameters such as temperature, humidity, air quality, noise levels, and light intensity; 2) Asset Tracking Sensors that are used for tracking assets such as vehicles, equipment, or packages, providing real-time location information; 3) Water Quality Sensors that monitor parameters like PH levels, temperature, turbidity, dissolved oxygen, and conductivity to ensure water quality in various applications; 4) Energy Monitoring Sensors that enable energy consumption monitoring for appliances, buildings, or industrial equipment, tracking energy efficiency and identifying areas for optimization; 5) Agriculture Sensors that monitor soil moisture, temperature, humidity, light levels, and rainfall to optimize irrigation, enhance crop health, and improve farm management; 6) Motion Detection Sensors that detect motion or changes in the surrounding environment, enabling applications like security systems, occupancy monitoring, or asset protection; 7) Gas and Chemical Sensors that detect and measure the concentration of gases and chemicals, including carbon monoxide, carbon dioxide, methane, volatile organic compounds (VOCs), etc.; 8) Industrial Sensors that offer various functionalities such as measuring pressure, vibration, temperature, or detecting faults in machinery to aid machine health monitoring and predictive maintenance; 9) Parking Sensors that monitor parking space occupancy and provide real-time data to optimize parking availability and guide drivers to available spaces; and 10) Smart City Sensors that monitor various aspects of smart cities, including air quality, waste management, parking, water management, and infrastructure monitoring.

NB-IoT (Narrowband Internet of Things) Sensors are designed for low-power, wide-area (LPWA) applications and can operate on 4G and 5G networks, and are ideal for applications such as smart cities, asset tracking, smart agriculture, and smart metering. There are several NB-IoT sensors available in the market designed for use in Narrowband Internet of Things (NB-IoT) applications. Some non-limiting examples of NB-IoT sensors that can be used in various applications, include: 1) Environmental Sensors that measure parameters such as temperature, humidity, air quality, noise levels, and light intensity; 2) Asset Tracking Sensors that are used for tracking assets such as vehicles, equipment, or packages, providing real-time location information; 3) Water Quality Sensors that monitor parameters like pH levels, temperature, turbidity, dissolved oxygen, and conductivity to ensure water quality in various applications; 4) Energy Monitoring Sensors that enable energy consumption monitoring for appliances, buildings, or industrial equipment, tracking energy efficiency and identifying areas for optimization; 5) Agriculture Sensors that monitor soil moisture, temperature, humidity, light levels, and rainfall to optimize irrigation, enhance crop health, and improve farm management; 6) Motion Detection Sensors that detect motion or changes in the surrounding environment, enabling applications like security systems, occupancy monitoring, or asset protection; 7) Gas and Chemical Sensors that detect and measure the concentration of gases and chemicals, including carbon monoxide, carbon dioxide, methane, volatile organic compounds (VOCs), etc.; 8) Industrial Sensors that offer various functionalities such as measuring pressure, vibration, temperature, or detecting faults in machinery to aid machine health monitoring and predictive maintenance; 9) Parking Sensors that monitor parking space occupancy and provide real-time data to optimize parking availability and guide drivers to available spaces; and 10) Smart City Sensors that monitor various aspects of smart cities, including air quality, waste management, parking, water management, and infrastructure monitoring.

Accordingly, the computing device 900 is an example of a system that includes a processor 910 and a memory 920 that includes instructions that (when executed by the processor 910) perform various embodiments of the present disclosure. Similarly, the memory 920 is an apparatus that includes instructions that when executed by a processor 910 perform various embodiments of the present disclosure.

The present disclosure may also be understood with reference to the following example of applying the present disclosure to a multistoried building to monitor for fires. When a fire breaks out on floor, for example, 20th floor, users on different floors are given different evacuation instructions. Users on lower floors (e.g., floors 19 and below) are directed to the closest fire escapes, but users located on higher floors can be directed to a subset of the available fire escapes, which may not necessarily be the closest fire escape on a given floor. Accordingly, the present disclosure directs these persons to the fire escapes with the least smoke, least risk of fire spreading to block the particular fire escape, fewest number of evacuces (e.g., to allow for faster evacuation and avoid bottlenecks), or otherwise improved ability to safely exit the multistoried building.

In this example, each floor and in each room/office/apartment thereof, the system includes various sensors (e.g., fire alarms, thermostats, smoke detectors, motion sensors, carbon monoxide detectors, etc.), which include cellular communication devices with N (e.g., five) preinstalled telephone numbers. These cellular communication devices may be add-ons or integrated with the sensors, and are configured via onboard logic to auto dial and send messages to the central service when an associated sensors is triggered. The various sensors may be placed according to local building codes, and in the present example include thermostat sensors placed in the stairwells at every location, with a fixing temperature limit F (e.g., F=70 degrees Celsius) to trigger when a stairwell is “hot” and is dangerous to use as an evacuation route. These stairwell readings can be augmented by the alerts generated by smoke detectors, carbon monoxide detectors, thermostats, etc. located on the various floors of a building to identify when a fire is approaching or near the stairwell, and may make the stairwell unsafe to use as an escape route (now or in the future). Additionally, voice calls received from user devices or audio identified by the sensors when triggered can be sent to the central service (e.g., directly or via a third-part transcription service) to identify further pertinent data from users located in the environment

These data are collected and processed via the central service, which may provide various outputs to different users and different devices. For example, a first web page comprised of headings in the order of receipt the various sensors can be provided to show the spread of the fire to evacuces or firefighters. In other web pages, different floors of the building can be shown individually, or collectively, with overlays of where and when the different status reports were received, a predicted incident flow for the fire, and/or evacuation routes and other response plans in reaction to the fire. These outputs can include maps that indicate the stairwells, temperatures, smoke content, air quality, number of persons in a given area, or the like.

Each floor in a web page can be divided into various text boxes that are sized and arranged to mimic the building. For example, a rectangular building may with stairwells located on either end of the rectangle can be represented by three boxes placed in a row for a first stairwell, a central living/apartment/office area, and a third stairwell, respectively. Text boxes can be shown with green and red colors; whenever any staircase/fire alarms are triggered, textbox changes color to red otherwise it is green to clearly differentiate safe and potentially dangerous escape routes. Additionally, various textual notes can be included in the text box indicating how many persons are located on each floor, when an alarm triggered, a current temperature, or the like. As the text and color of the various boxes require less overhead to transmit than graphical maps, the central service can reduce the amount of data transmitted among the various devices to accurately represent the state of the incident to prior solutions, while still presented an easy to read interface to multiple devices.

In addition to the embodiments described above, many examples of specific combinations are within the scope of the disclosure, some of which are detailed below:
Clause 1: A method including various operations, a system, comprising: a processor; and a memory including instructions, that when executed by the processor perform various operations, or a computer readable storage medium including instructions that when executed by a processor perform various operations, the operations comprising: identifying, at a central service, a plurality of user devices to receive a reaction plan for an ongoing incident in an environment; customizing the reaction plan to produce a plurality of individualized versions, wherein each individualized version corresponds to an individual user device of the plurality of user devices and is customized based a device type of each individual user device and a role of a user associated with each individual user device in responding to the ongoing incident; and transmitting the individualized version to each corresponding individual user device of the plurality of user devices.

Clause 2: Wherein the operations set forth in any of clauses 1-10 include that customizing the reaction plan includes at least one of: generating and populating a first graphical user interface (GUI) for a first user device of the plurality of user devices and a second GUI for a second user device of the plurality of user devices, wherein the first GUI and the second GUI include different amounts of data; and generating and populating a first sonic alert or instruction for output by the first user device of the plurality of user devices and no sonic alert for the second user device of the plurality of user devices.

Clause 3: Wherein the operations set forth in any of clauses 1-10 include that the reaction plan is generated by central service: receiving, from a wireless communication device associated with a sensor deployed in the environment with a plurality of sensors, a status report; verifying a location of the sensor in the environment; updating a map of the environment with the status report; processing pending status reports, including the status report, to identify an incident flow; and generating the reaction plan based on the map and the incident flow.

Clause 4: Wherein the operations set forth in any of clauses 1-10 include that a first user device of the plurality of user devices is associated with the environment by the central service and not located in the environment; a second user device of the plurality of user devices is located in the environment and not associated with the environment by the central service; and a third user device of the plurality of user devices is located in the environment and associated with the environment by the central service.

Clause 5: Wherein the operations set forth in any of clauses 1-10 include in response to detecting an unassociated user in the environment via one or more of a plurality of sensors deployed in the environment that is not associated with any user device of the plurality of user devices, transmitting the reaction plan to one or more sensors of the plurality of sensors within a predefined distance of the unassociated user for output into the environment.

Clause 6: Wherein the operations set forth in any of clauses 1-10 include that the unassociated user is non-human.

Clause 7: Wherein the operations set forth in any of clauses 1-10 include that the reaction plan as customized is a refusal reaction plan for a given user who is not located in the environment or associated with the environment by the central service that actively prevents communication between an given user device associated with the given user and the central service while the given user device is within a predefined distance of the environment.

Clause 8: Wherein the operations set forth in any of clauses 1-10 include, in response to receiving inputs from a user of the plurality of user or a sensor located in the environment: updating the reaction plan; and customizing and transmitting the reaction plan as updated to each user device of the plurality of user devices.

Clause 9: Wherein the operations set forth in any of clauses 1-10 include that the ongoing incident is identified by a first set of sensors deployed in the environment that are operated by a first party, the operations further comprising: collecting data from a second set of sensors deployed outside of the environment that are operated by a second party; and generating the reaction plan according to the data from the first set of sensors deployed in the environment and the data collected from the second set of sensors.

Clause 10: Wherein the operations set forth in any of clauses 1-10 include that the ongoing incident is identified by a first set of sensors deployed in the environment that are operated by a first party, the operations further comprising: commanding at least a subset of the first set of sensors to change a data reporting rate based on a sensor type for the subset of the sensors and an incident type of the ongoing incident.

Certain terms are used throughout the description and claims to refer to particular features or components. As one skilled in the art will appreciate, different persons may refer to the same feature or component by different names. This document does not intend to distinguish between components or features that differ in name but not function.

As used herein, “about,” “approximately” and “substantially” are understood to refer to numbers in a range of the referenced number, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole numbers, or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in the present disclosure, a phrase referring to “at least one of” a list of items refers to any set of those items, including sets with a single member, and every potential combination thereof. For example, when referencing “at least one of A, B, or C” or “at least one of A, B, and C”, the phrase is intended to cover the sets of: A, B, C, A-B, B-C, and A-B-C, where the sets may include one or multiple instances of a given member (e.g., A-A, A-A-A, A-A-B, A-A-B-B-C-C-C, etc.) and any ordering thereof. For avoidance of doubt, the phrase “at least one of A, B, and C” shall not be interpreted to mean “at least one of A, at least one of B, and at least one of C”.

As used in the present disclosure, the term “determining” encompasses a variety of actions that may include calculating, computing, processing, deriving, investigating, looking up (e.g., via a table, database, or other data structure), ascertaining, receiving (e.g., receiving information), accessing (e.g., accessing data in a memory), retrieving, resolving, selecting, choosing, establishing, and the like.

Without further elaboration, it is believed that one skilled in the art can use the preceding description to use the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

Within the claims, reference to an element in the singular is not intended to mean “one and only one” unless specifically stated as such, but rather as “one or more” or “at least one”. Unless specifically stated otherwise, the term “some” refers to one or more. No claim element is to be construed under the provision of 35 U.S.C. § 112 (f) unless the element is expressly recited using the phrase “means for” or “step for”. All structural and functional equivalents to the elements of the various embodiments described in the present disclosure that are known or come later to be known to those of ordinary skill in the relevant art are expressly incorporated herein by reference and are intended to be encompassed by the claims. Moreover, nothing disclosed in the present disclosure is intended to be dedicated to the public regardless of whether such disclosure is explicitly recited in the claims.

The invention is claimed as follows:

1. A method, comprising:
identifying, at a central service, a plurality of user devices to receive a reaction plan for an ongoing incident in an environment;
customizing the reaction plan to produce a plurality of individualized versions, wherein each individualized version corresponds to an individual user device of the plurality of user devices and is customized based a device type of each individual user device and a role of a user associated with each individual user device in responding to the ongoing incident; and
transmitting the individualized version to each corresponding individual user device of the plurality of user devices.

2. The method of claim 1, wherein customizing the reaction plan includes at least one of:
generating and populating a first graphical user interface (GUI) for a first user device of the plurality of user devices and a second GUI for a second user device of the plurality of user devices, wherein the first GUI and the second GUI include different amounts of data; and
generating and populating a first sonic alert or instruction for output by the first user device of the plurality of user devices and no sonic alert for the second user device of the plurality of user devices.

3. The method of claim 1, wherein the reaction plan is generated by central service:
receiving, from a wireless communication device associated with a sensor deployed in the environment with a plurality of sensors, a status report;
verifying a location of the sensor in the environment;
updating a map of the environment with the status report;
processing pending status reports, including the status report, to identify an incident flow; and
generating the reaction plan based on the map and the incident flow.

4. The method of claim 1, wherein:
a first user device of the plurality of user devices is associated with the environment by the central service and not located in the environment;
a second user device of the plurality of user devices is located in the environment and not associated with the environment by the central service; and
a third user device of the plurality of user devices is located in the environment and associated with the environment by the central service.

5. The method of claim 1, further comprising:
in response to detecting an unassociated user in the environment via one or more of a plurality of sensors deployed in the environment that is not associated with any user device of the plurality of user devices, transmitting the reaction plan to one or more sensors of the plurality of sensors within a predefined distance of the unassociated user for output into the environment.

6. The method of claim 5, wherein the unassociated user is non-human.

7. The method of claim 1, wherein the reaction plan as customized is a refusal reaction plan for a given user who is not located in the environment or associated with the environment by the central service that actively prevents communication between an given user device associated with the given user and the central service while the given user device is within a predefined distance of the environment.

8. The method of claim 1, further comprising, in response to receiving inputs from a user of the plurality of user or a sensor located in the environment:
updating the reaction plan; and
customizing and transmitting the reaction plan as updated to each user device of the plurality of user devices.

9. The method of claim 1, wherein the ongoing incident is identified by a first set of sensors deployed in the environment that are operated by a first party, the method further comprising:
collecting data from a second set of sensors deployed outside of the environment that are operated by a second party; and
generating the reaction plan according to the data from the first set of sensors deployed in the environment and the data collected from the second set of sensors.

10. The method of claim 1, wherein the ongoing incident is identified by a first set of sensors deployed in the environment that are operated by a first party, the method further comprising:
commanding at least a subset of the first set of sensors to change a data reporting rate based on a sensor type for the subset of the sensors and an incident type of the ongoing incident.

11. A system, comprising:
a processor; and
a memory including instructions, that when executed by the processor perform operations comprising:
identifying, at a central service, a plurality of user devices to receive a reaction plan for an ongoing incident in an environment;
customizing the reaction plan to produce a plurality of individualized versions, wherein each individualized version corresponds to an individual user device of the plurality of user devices and is customized based a device type of each individual user device and a role of a user associated with each individual user device in responding to the ongoing incident; and
transmitting the individualized version to each corresponding individual user device of the plurality of user devices.

12. The system of claim 11, wherein customizing the reaction plan includes at least one of:
generating and populating a first graphical user interface (GUI) for a first user device of the plurality of user devices and a second GUI for a second user device of the plurality of user devices, wherein the first GUI and the second GUI include different amounts of data; and
generating and populating a first sonic alert or instruction for output by the first user device of the plurality of user devices and no sonic alert for the second user device of the plurality of user devices.

13. The system of claim 11, wherein the reaction plan is generated by central service:
receiving, from a wireless communication device associated with a sensor deployed in the environment with a plurality of sensors, a status report;
verifying a location of the sensor in the environment;
updating a map of the environment with the status report;
processing pending status reports, including the status report, to identify an incident flow; and
generating the reaction plan based on the map and the incident flow.

14. The system of claim 11, wherein:
a first user device of the plurality of user devices is associated with the environment by the central service and not located in the environment;
a second user device of the plurality of user devices is located in the environment and not associated with the environment by the central service; and
a third user device of the plurality of user devices is located in the environment and associated with the environment by the central service.

15. The system of claim 11, further comprising:
in response to detecting an unassociated user in the environment via one or more of a plurality of sensors deployed in the environment that is not associated with any user device of the plurality of user devices, transmitting the reaction plan to one or more sensors of the plurality of sensors within a predefined distance of the unassociated user for output into the environment.

16. The system of claim 15, wherein the unassociated user is non-human.

17. The system of claim 11, wherein the reaction plan as customized is a refusal reaction plan for a given user who is not located in the environment or associated with the environment by the central service that actively prevents communication between an given user device associated with the given user and the central service while the given user device is within a predefined distance of the environment.

18. The system of claim 11, further comprising, in response to receiving inputs from a user of the plurality of user or a sensor located in the environment:
updating the reaction plan; and
customizing and transmitting the reaction plan as updated to each user device of the plurality of user devices.

19. The system of claim 11, wherein the ongoing incident is identified by a first set of sensors deployed in the environment that are operated by a first party, the method further comprising:
collecting data from a second set of sensors deployed outside of the environment that are operated by a second party; and
generating the reaction plan according to the data from the first set of sensors deployed in the environment and the data collected from the second set of sensors.

20. The system of claim 11, wherein the ongoing incident is identified by a first set of sensors deployed in the environment that are operated by a first party, the method further comprising:
commanding at least a subset of the first set of sensors to change a data reporting rate based on a sensor type for the subset of the sensors and an incident type of the ongoing incident.
